(19) United States
(12) Patent Application Publication
(10) Pub. No.: US 2018/0121961 A1
(43) Pub. Date: May 3, 2018

(54) SYSTEMS AND METHODS FOR FOOD WASTE REDUCTION

(71) Applicant: Amalgamate, LLC, Austin, TX (US)

(72) Inventor: Gilbert Villanueva, Austin, TX (US)

(21) Appl. No.: 15/801,939

(22) Filed: Nov. 2, 2017

Related U.S. Application Data
(60) Provisional application No. 62/416,639, filed on Nov. 2, 2016.

(51) Int. Cl. G06Q 30/02; G06Q 10/08; H04N 7/18; B60P 3/20

(52) U.S. Cl. CPC G06Q 30/0264; G06Q 30/0255; G06Q 10/087; G06Q 10/0832; B60P 3/205; G06Q 10/0833; H04N 7/185

(57) ABSTRACT

In some embodiments, a method may include distributing foodstuffs. In some embodiments, a method may include preparing a foodstuff from a distributor for purchase. The foodstuff may be nearing expiration. The method may include capturing an image of the foodstuff using an image capture device. The image capture device may include a dedicated device. The method may include uploading and displaying the image on a software application to a server. The method may include offering for purchase the foodstuff using the software application. The method may include providing a purchased foodstuff to a consumer who has purchased the foodstuff using the software application. In some embodiments, the method may include delivering the purchased foodstuff to the consumer. In some embodiments, the method may include tracking a position of the purchased foodstuff during delivery. In some embodiments, the method may include monitoring at least one parameter of the purchased foodstuff during delivery.

### PRIORITY CLAIM

This application is a claims priority to U.S. Provisional Patent Application No. 62/416,639 entitled “SYSTEMS AND METHODS FOR FOOD WASTE REDUCTION” filed on Nov. 2, 2016, all of which is incorporated by reference herein.

### BACKGROUND OF THE INVENTION

### 1. Field of the Invention

The present disclosure generally relates to systems and methods for selling, tracking, and distributing foodstuffs close to expiration. More particularly, the disclosure generally relates to systems and methods for capturing images of meals prepared from nearly expired foodstuffs for selling to potentials clients and delivering, including tracking, said meals.

### 2. Description of the Relevant Art

Currently food waste is at an all-time high especially in the U.S. It is estimated that one third of all food produced in the world goes to waste. Forty percent of food produced in the States is simply thrown away. From restaurant scraps, to grocers disposing of imperfect produce, to spoiled food, roughly $400B in food ends up in landfills every year resulting in 3.3 billion metric tons of greenhouse gases annually.

### SUMMARY

In some embodiments, a method and/or system may function to coordinate the distribution and/or sale of foodstuffs. Food items may be provided in the form of prepared meals. In various embodiments, the system may include distributing prepared meals and/or bulk food in which at least some of the ingredients are close to expiration. Vendors may offer up for sale foodstuffs which are coming close to expiration at a potentially discounted price as opposed to the food being thrown away as is currently done. The food may be offered in bulk as is and/or the food may be prepared into ready to eat meals by the vendor. Foodstuffs may be delivered via a vehicle or plurality of vehicles provided by the distributor and/or delivery may be accomplished by independent contractors. Contractors may work full time and/or work whatever hours they wish by simply logging into a system remotely to inform the distributor that they are available to make deliveries. In some embodiments, a mobile electronic software application is used by participants to provide or procure food through the system.

### BRIEF DESCRIPTION OF THE DRAWINGS

Advantages of the present invention may become apparent to those skilled in the art with the benefit of the following detailed description of the preferred embodiments and upon reference to the accompanying drawings.

FIG. 1 depicts a diagram of a system for selling, tracking, and distributing foodstuffs.

FIG. 2 depicts a diagram of a system for selling, tracking, and distributing foodstuffs using a vehicle including a plurality of easily accessible dedicated containers.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicated open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third die electrically connected to the module substrate” does not preclude scenarios in which a “fourth die electrically connected to the module substrate” is connected prior to the third die, unless otherwise specified. Similarly, a “second” feature does not require that a “first” feature be implemented prior to the “second” feature, unless otherwise specified.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 paragraph (f), interpretation for that component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

It is to be understood the present invention is not limited to particular devices or biological systems, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Thus, for example, reference to “a linker” includes one or more linkers.

### DETAILED DESCRIPTION

### Definitions

Unless defined otherwise, all technical and scientific terms used herein have the same meaning as commonly understood by one of ordinary skill in the art.

The term “connected” as used herein generally refers to pieces which may be joined or linked together.

The term “coupled” as used herein generally refers to pieces which may be used operatively with each other, or joined or linked together, with or without one or more intervening members.

The term “directly” as used herein generally refers to one structure in physical contact with another structure, or, when used in reference to a procedure, means that one process effects another process or structure without the involvement of an intermediate step or component.

The term “vendor” as used herein generally refers to is a supply chain management term that means anyone who provides goods or services to a company or individuals. A vendor often manufactures or produces items, and sells those items to a customer and specifically herein items may refer to foodstuff and/or meals.

A mobile electronic software application may function to coordinate the redistribution and/or sale of foodstuffs which are close to expiration. Vendors (e.g., restaurants, caterers, grocery stores, food distributors, etc.) may offer up for sale foodstuffs which are coming close to expiration at a potentially discounted price as opposed to the food being thrown away as is currently done. The food may be offered in bulk as is and/or the food may be prepared into ready to eat meals by the vendor.

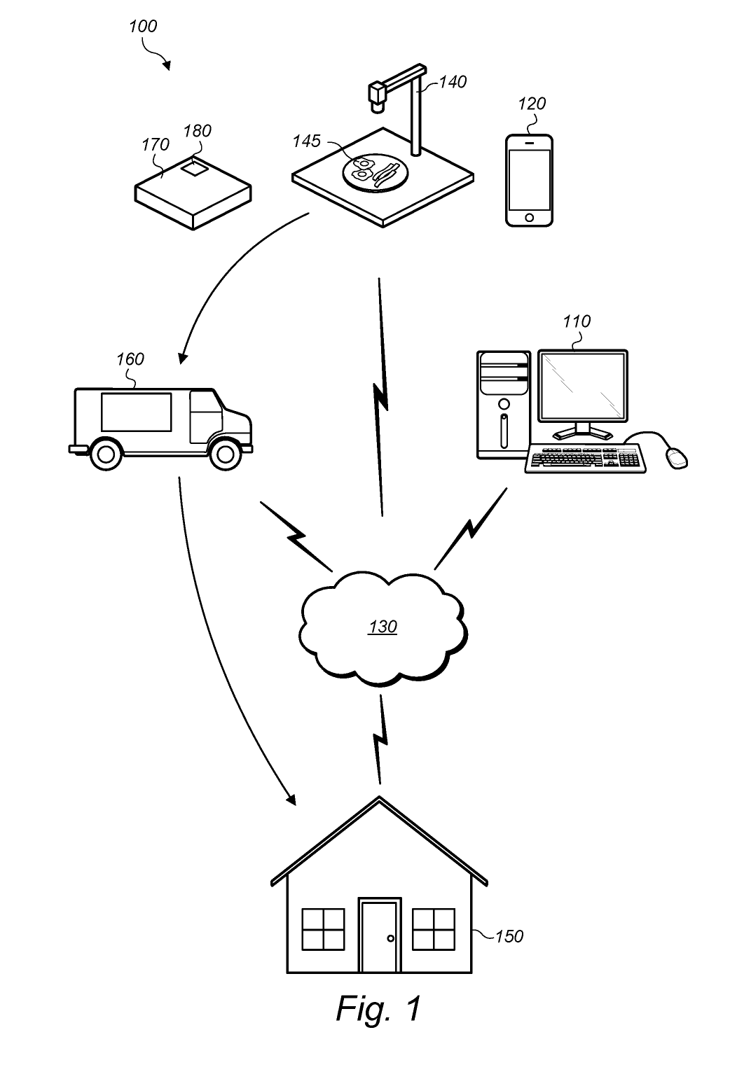

FIG. 1 depicts a diagram of a system 100 for selling, tracking, and distributing foodstuffs. In various embodiments, the system may include providing meals including ingredients that are close to expiration. “Foodstuffs” may include prepared meals, individual food items, raw ingredients, beverages, entrees, side dishes, or desserts. In some cases, the system is used for prepared meals. In some embodiments, the vendor may upload a photograph and/or description (e.g., including ingredients especially for people with food allergies) to a web site on, for example, a server 110 using a computer or mobile application 120 via the interne 130. In some embodiments, a system may include a tangible, computer-readable medium, including program instructions configured to implement one or more methods described herein. In some embodiments, expired foods will not be allowed to be sold and offending vendors may be blocked temporarily or permanently from participating (or blocked for transgressing any other rules associated with the service). In some cases, a vendor may have multiple entries of the same entry and may enter this in the web site. Entries listed for sale may be removed from the web site once purchased (e.g., automatically) or by the vendor as necessary for various other reasons.

In some embodiments, a dedicated image capture system 140 may be available at the vendor's place of business for photographing meals 145 facilitating the process for vendors which participate on a regular basis. In some embodiments, a dedicated image capture system may be available to a driver or associated with a delivery vehicle such that an image capture system is available to vendors who do not have one. In some embodiments, an image capture system may include a camera, a digital camera, a mobile phone camera, or a camera associated with a computer. A standardized image capture system may provide more standardized and better quality images such that an overall more professional and appealing look is achieved for the consumer. This may be especially true for vendors who do not have as much experience with new technology. The image capture system may interface with a computer or mobile device wirelessly or via a wired connection (for example, for control of the image capture system and/or to transfer images.).

Consumers 150 may visit the web site or download an app to their cellular phone to view listed entries from vendors. The consumer may conduct searches for meal entries using various filters (e.g., location, distance, type of food, delivery options, ingredients (desired and/or avoided) etc.). The consumer may use the site to pay for a desired entry. The consumer may have the option for delivery 160 (e.g., with an additional fee). The consumer may have an option to decide where the food is delivered. The consumer may have the option to leave reviews or offer feedback regarding the delivery and/or the food entry itself. The consumer may have the option to track the entry delivery in real time using the software interface and GPS.

In some cases, wherein the food entry is delivered, a deliverer may access the site and register as a driver. When a consumer buys a meal entry and expresses a desire to have the meal entry delivered active drivers may be notified and any driver that is interested accepts the delivery job. The site may determine what drivers are locally available to deliver and only notify those drivers (specifically drivers in the area that are logged in as active drivers). The driver is then provided the necessary data to make the delivery. The driver is then paid by the site and/or the consumer.

In some cases, technology (e.g., RFID, bar codes, etc.) may be used to track the food entry (e.g., position and/or environmental conditions). In one embodiment, a bar code tag is attached to each prepared meal. Information about the ingredients of the meal, including expiration date, may be associated with the meal and available as the meal moves through the distribution system to the customer.

In some embodiments, a foodstuffs container 170 may include associating the control of a foodstuffs container with a product profile. Moreover, the process of packaging, tracking, delivering, etc. the foodstuffs container and/or products stored therein may be controlled from a centralized location (e.g., server 110). The centralized location may be connected to each of the foodstuffs container using a real-time analytic software application (e.g., using a Cloud-based network such as interne 130). In some approaches, each food product may be associated with (e.g., assigned to) a profile that reflects the ideal operating parameters (e.g., delivery conditions which may vary over time) for the foodstuffs container. In different approaches, the parameters may include a temperature in the product container, a relative humidity in the product container, whether the container is open or closed, a power status associated with the product container, shock and/or vibration experienced by the foodstuffs container, a reference amount of time, etc., and/or other environmental conditions. It follows that the product container preferably maintains a delivery environment at least similar to the ideal operating parameters. In some approaches, the characteristics of the delivery environment may preferably be kept in respective ranges, or above or below a particular threshold level. For instance, the ambient temperature in the product container may preferably be kept between a maximum and minimum temperature.

In some embodiments, a foodstuffs container may incorporate one or more sensors 180. The sensor may include a temperature sensor. The sensor may include a line voltage sensor for the 12V DC supply voltage (e.g., for use in a car). In some embodiments, an external light sensor may be mounted to detect when the foodstuffs container is open (light sensed) or closed (no light sensed). The temperature and supply voltage may be monitored at any desired frequency (e.g., once a minute) by polling the sensors. However, the light sensor may be continually monitored (e.g., on an interrupt basis). All of the sensor information is preferably “published” to a Cloud-based application on a configured interval. The foodstuffs container sensor may push the data via its wireless (e.g., Bluetooth, wifi, radio frequency identification, etc.) communication port (e.g., which has been paired to the driver's mobile phone). However, in some approaches a wired (physical) connection may be used, e.g., such as an Ethernet cable, a wire, a bus, etc. The mobile phone may be running an application that accepts the wireless communication, adds a local timestamp and/or GPS location information, and pushes the total message to a management system cloud application.

The management system may receive the information in its incoming message queue, and may immediately analyze the sensor readings against parameters based on the product profile associated with the tag ID. The management system captures the foodstuffs container load time and location, the product profile associated with the specific tag ID, and any product data that is specific, such as condition of product when prepared, from which it determines the foodstuffs container parameters. For instance, in one embodiment, if a hot meal (e.g., chicken teriyaki rice bowl) is prepared with ingredients cooked within 15 minutes of loading the foodstuffs container, the parameters may be set to maintain a foodstuffs container of at least 130 F, and no more than 150 F, and the food may be available for four hours from loading. If the container temperature should fall below the 130 F, it may degrade the time available in relation to how low the temperature is, and for how long the low temperature is maintained (e.g., change in temperature over change in time). There may also be pre-determined minimum temperature to disqualify the food, e.g., when it becomes unsafe. The management system may monitor the time, temperature, supply voltage, container light sensor, etc., to determine if the food is being properly maintained.

In some embodiments, the foodstuffs container may be a smart foodstuffs container. A smart foodstuffs container may include a bag, box, carton, etc., also having environmental controls incorporated therewith. It follows that any one or more features disclosed herein may be implemented in different embodiments, preferably in order to maintain desired operating parameters (e.g., ambient temperature in the foodstuffs container).

Moreover, foodstuffs container may be able to report current delivery conditions when possible, to a centralized location. Thus, the status information received may come directly from the foodstuffs container. The foodstuffs container may include a component configured to transmit information, thereby enabling the foodstuffs container to send status information to a centralized location (e.g., computer, control center, processor, etc.). In some approaches, a network (e.g., cloud-based network) may be used to transmit the information to the central location.

In some embodiments, the characteristics of the food production or storage environment are monitored and/or controlled. For instance, the ambient temperature at the restaurant where the ingredients of the meal are kept, meals are being prepared, stored, or shipped may be monitored based or controlled using the system.

In some embodiments, a system or method may provide a dynamic price sales method for varying a product's price according to the time elapsed from the manufacture date/hour to time of sale. This automated variable pricing may be based according to predetermined data relating to the valid period.

In some embodiments, meals may be transported using autonomous vehicles. Autonomous vehicles may be specialized vehicles that function to transport food. In some cases, these specialized vehicles may be custom manufactured and/or modified versions of publically available vehicles. An autonomous car may include a vehicle that is capable of sensing its environment and navigating without (or with very little) human input. Autonomous cars may detect surroundings using a variety of techniques such as radar, lidar, GPS, odometry, and/or computer vision. Advanced control systems interpret sensory information to identify appropriate navigation paths, as well as obstacles and relevant signage. Autonomous cars may have control systems that are capable of analyzing sensory data to distinguish between different cars on the road, which is very useful in planning a path to the desired destination.

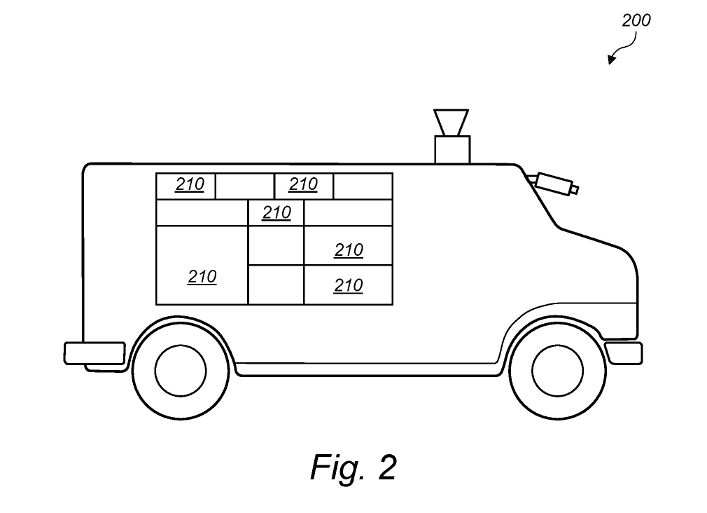

In some embodiments, the autonomous vehicle may include a plurality of compartments for transporting meals. FIG. 2 depicts a diagram of a delivery vehicle 200 including a plurality of easily accessible dedicated compartments 210 used in a system for selling, tracking, and distributing foodstuffs. As noted above, the foodstuffs may be in the form of meals having ingredients that are close to expiration. The autonomous vehicle may be a self-driving vehicle. The vehicle may include a system for automatically dispensing items from the various compartments. Dispensing may be done in conjunction with orders placed using the software application described above. It should be noted that although FIG. 2 depicts a more conventional vehicle in the sense that it uses wheels etc., this should not be seen as limiting. Other vehicles currently being researched could be used such as “flying cars”, hover vehicles, or other modes of transportation.

In some embodiments, one or more security protocols may be utilized to control access to one or more of the compartments. In some embodiments, biometric authentication may be used to verify the identity of a purchaser before allowing access to a compartment. Biometric authentication may include facial recognition, fingerprint recognition, hand geometry biometrics, retina scan, iris scan, signature analysis, and/or voice analysis. Several of the biometric authentication methods are currently incorporated in cellular phones. As such the biometric authentication might be tied to a cellular phone or other portable device carried by the purchaser. Biometric authentication systems may be built into the food compartments/delivery system. A combination of both purchaser devices and delivery system devices may be used to verify the identity of the purchaser. Such security features would be beneficial for other uses as well. For example, similar delivery systems might be used to deliver non edible products that include anything from sealed documents to craigslist purchases or prescription medicine or prescription related products (a separate vehicle may be used for transporting non edible products). In some embodiments, non edible secure documents may be delivered in the form of mail as one or more of the compartments may function as a mobile mail box (e.g., P.O. Box). The mail boxes may be privately managed mail boxes or managed by a government entity (e.g., the USPS).

Each compartment may include a prepared meal or food item. The compartments may be available in a variety of sizes. In some embodiments, the size of one or more compartments may be adjustable. For example, a wall between two adjoining compartments may be removed and the doors coupled (e.g., actually mechanically and/or electronically (e.g., such that the doors open together when the meal is requested for sale by a customer)) or two or more smaller compartments may be removed and replaced by with a larger compartment of equal or smaller volume compared to the cumulative volume of the smaller compartments. The compartments may be insulated in order to preserve the freshness of the meal.

In some embodiments, the compartments may allow heating and/or cooling of the meal using refrigeration or heating elements as necessary. Naturally the temperature of one or more compartments may be adjustable. Alternatively, and perhaps more efficiently, separate compartments may not include meals normally and are reserved for quickly heating (e.g., a microwave) and/or cooling or freezing purchased meals. In some embodiments, there may be a section for drinks to be stored and kept at cooler temperature as opposed to other compartments and/or may be insulated to retain warmer temperatures. There may be a compartment available to purchase utensils, napkins, straws, sugar/sweeteners, creamers, salt/pepper, and/or condiments.

In some embodiments, uncooked produce, proteins, and other edibles may be transported using systems and methods described herein. Edibles may be properly secured and packaged as necessary. As such grocery stores, markets, boutique food stores, etc. could have access to the services provided by the systems and methods described herein. In some embodiments, beverages, including alcohol and non-alcohol beverages may be purchased and delivered by the systems and methods described herein (e.g., from liquor stores, corner stores, and bars/restaurants for bulk and/or individual orders).

In some embodiments, the autonomous vehicle (or any type of delivery vehicle) may accept a variety of forms of payment for the meals. The vehicle may accept credit cards, cash or coins. However, in some embodiments, the autonomous vehicle may primarily accept electronic forms of payment. Electronic forms of payment may include Apple pay, Samsung pay, Android pay, online payment (e.g., computer website, cellphone application, etc.) Especially in the case of electronic payments, a customer may receive a verification code to key into their designated compartment or section for their food. Upon removal of the meal from the designated compartment, that compartment(s) will no longer be available until an approved vendor has submitted another meal to be added to that vehicle.

In some embodiments, vendors may submit meals or foodstuffs through a login portal. Vendors may login through an online portal, select the amount of compartments the Vendor wishes to reserve, and what meals the Vendor will be selling. In some embodiments, the vendor may select a designated time for picks ups for the vehicle to arrive at the vendor's establishment and what size compartments the vendor desires. Upon proper submission by the vendor of all required information, a vehicle will arrive at its designated time and depart after the vendor has stored all meals in their designated compartments and have electronically approved that all meals are secured. In some embodiments, a vendor may be notified electronically when a vehicle is on its way, near, and/or arrived at the vendor's establishment. In some embodiments, a vehicle may stay at the vendor's establishment for a predetermined period of time waiting for a vendor before either sending the vendor an additional notice alerting the vendor and/or leaving for a subsequent delivery or pickup.

In some embodiments, upon stocking a vehicle, the information a vendor has provided for the customer will be posted online for customers to review and purchase. In some embodiments, after the customer has selected their meal or variety of meals, the customer will receive an identification number that will be required for authorization to access the vendor's compartment in the delivery vehicle. In some embodiments, customers will also have the option to pay with phone pay, the same process that retailers offer customers at their registers. In some embodiments, customers may have the option to pay with credit cards at a main terminal on the vehicle. For credit card paying customers, customers may view what selections are available in the vehicle through a touch screen (or directly looking through transparent portions of a compartment) and also check out through that touch screen after selecting all items for purchase. Customers who have an account may be able to pay with one touch payment. Customers who paid online may receive a notification that their vehicle is on its way and an approximate time of arrival. Customers may be able to track in real or near real time throughout the delivery process via a web portal and/or a portable electronic device application.

In some embodiments, customers who have an application or are registered with the web site may receive notifications that a designated vehicle will be in their area at an approximate time frame and the contents that it carries or the food vendors that have food/drinks on this vehicle. Customers may open the notification and view all contents available for purchase in the vehicle. Customers may have the option to filter or personalize notifications, for example, for specific food vendors and/or a specific time frame.

In some embodiments, vehicles may be used for advertising to increase revenues. For example, vendors may pay to include advertising on the vehicle by applying a logo, a name, or a campaign across the vehicle. Advertisers will have the option to lease a portion of space or the whole vehicle. For example, automotive wrap such as the different variations of vinyl wraps for automobiles may be used for advertising. Other forms of advertising may be used as well (e.g., LED screens, image projections, augmented and virtual reality projection, mixed reality, hologram projection, etc.). In some embodiments, advertising may be sold on the web site or displayed on the mobile application.

In some embodiments, vendors may include restaurants, caterers, movie theaters, museums or any place that sells food. A vendor may promote their food related products through the related web site and application and/or for distributing samples. This may be for promoting food that these establishments will offer for sale, currently or in the future or for testing potential food products or seasonal products. In some embodiments, vendors may be able to create their food or drink specials that they want to experiment with by testing it through the web site or application to evaluate sales and volume to possibly add to their menu. Meals or foodstuffs sold may be sold at a marked up to discounted rate. Vendors may add new items at any time. In some embodiments, customers that purchase promotional items may request to order more of said items from vendors as long as restaurant is still providing the promotional product. Customer feedback may be relayed back to vendor for rating of food/drinks with the option of anonymous or public profile submitted in the event that vendor may want to contact customer to further engage in feedback. Vendors may offer their own promotional programs through the web site/application such as but not limited to, free or discounted vouchers to customers for referrals. Promotional items sold on the web site/application may be available for pick up or delivery.

Computer systems implemented for implementing various aspects of the processes described herein may, in various embodiments, include components such as a CPU with an associated memory medium such as Compact Disc Read-Only Memory (CD-ROM). The memory medium may store program instructions for computer programs. The program instructions may be executable by the CPU. Computer systems may further include a display device such as monitor, an alphanumeric input device such as keyboard, and a directional input device such as mouse. Computer systems may be operable to execute the computer programs to implement computer-implemented systems and methods. A computer system may allow access to users by way of any browser or operating system.

Computer systems may include a memory medium on which computer programs according to various embodiments may be stored. The term “memory medium” is intended to include an installation medium, e.g., Compact Disc Read Only Memories (CD-ROMs), a computer system memory such as Dynamic Random Access Memory (DRAM), Static Random

Access Memory (SRAM), Extended Data Out Random Access Memory (EDO RAM), Double Data Rate Random Access Memory (DDR RAM), Rambus Random Access Memory (RAM), etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to implement embodiments as described herein. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU executing code and data from the memory medium may include a means for creating and executing the software program or programs according to the embodiments described herein.

Although in various embodiments described herein, systems are used to manage, package, sell, and distribute food that is close to expiration, the systems and processes described may nevertheless in various embodiments be employed to package, sell, and distribute other food, beverages, or consumable items (e.g., foods that are not close to expiration).

Although in the system shown in FIG. 2, the system automatically dispenses meal from a self-driving vehicle, the automatic mobile dispensing device described above may be include on a vehicle operated by a human driver.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system for providing food, comprising:
an image capture system configured to capture images of food to be sold to customers;
one or more customer computing devices configured to view images of the imaged food and to accept orders for the food; and
a vehicle configured to transport the food to customers who have purchased the food.

2. The system of claim 1, wherein the vehicle comprises a self-driving vehicle.

3. The system of claim 1, further comprising one or more sensors configured to sense one or more conditions of the food items or one or more conditions of the environment in which the food items are kept.

4. The system of claim 1, further comprising one or more tracking devices configured to track the location of one or more food items.

5. The system of claim 1, further comprising one or more identification devices configured to identify one or more of the food items.

6. The system of claim 1, wherein the vehicle comprises a plurality of compartments, wherein the compartments are configured to securely hold food items, wherein the compartments are configured to be openable to dispense selected food items to customers who have ordered or purchased the food items.

7. The system of claim 1, wherein the plurality of compartments comprise an adjustable size of two or more of the compartments such that a compartment size is configured to be increased and/or decreased.

8. The system of claim 1, wherein the vehicle comprises a self-serve system, wherein the self-serve system is configured to dispense food items based on the actions of the customer.

9. The system of claim 1, wherein the vehicle comprises a self-serve system, wherein the self-serve system is configured to dispense food items that were placed over a network from one or more food establishments by way of a software application.

10. The system of claim 1, wherein the vehicle comprises a self-driving vehicle.

11. A method of distributing foodstuffs nearing expiration:
preparing a foodstuff from a distributor for purchase, wherein the foodstuff is nearing expiration;
capturing an image of the foodstuff using an image capture device;
uploading and displaying the image on a software application to a server;
offering for purchase the foodstuff using the software application; and
providing a purchased foodstuff to a consumer who has purchased the foodstuff using the software application.

12. The method of claim 11, wherein the foodstuff comprises a meal including at least some ingredients that are close to expiration.

13. The method of claim 11, further comprising delivering the purchased foodstuff to the consumer.

14. The method of claim 13, further comprising tracking a position of the purchased foodstuff during delivery.

15. The method of claim 13, further comprising monitoring at least one parameter of the purchased foodstuff during delivery.

16. The method of claim 11, further comprising collecting feedback from the disposition of the foodstuffs, and using the feedback to promote sale of one or more food items.

17. The method of claim 11, wherein the software application is configured to allow the consumer acquiring food items to view a food item to be purchased, purchase the food items, order delivery of the food item, and track the food item during delivery.

18. A system, comprising:
a vehicle configured to transport food items, a food dispensing system coupled to the vehicle, wherein the food dispensing system is configured to automatically dispense food from one or more compartments based on the actions of one or more customers or operators.

19. The system of claim 18, wherein the vehicle comprises a self-driving vehicle.

20. The system of claim 18, further comprising one or more sensors configured to sense one or more conditions of the food items or one or more environmental conditions of the food during transport.
